(19) United States
(12) Patent Application Publication
(10) Pub. No.: US 2002/0128960 A1
(43) Pub. Date: Sep. 12, 2002

(54) Systems and methods for managing accounts

(76) Inventors: Kenneth G. Lambiotte, Richmond, VA (US); David L. Arnett, Boise, ID (US); Alan G. DeGeorge, Boise, ID (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/750,182

(22) Filed: Dec. 29, 2000

(51) Int. Cl. G06F 17/60

(52) U.S. Cl. 705/38

(57) ABSTRACT

A system and method is provided for determining whether to contact a party associated with an account. The disclosed system places a value on an account, estimates a cost in contacting the account holder or customer, and attempts contact if the account value exceeds the estimated cost. The account value is an amount the customer likely would pay if he were contacted or agreed to make a purchase. It is based on the customer's financial situation and credit history. The cost in contacting a customer is determined from a probability of contacting the customer. The probability is based largely on the customer's demographic information, including the mobility of the population in his demographic area and the number of people having telephone service in that area. The system determines that a customer will be hard to contact if he lives in a highly mobile area or in an area wherein most of the population lacks telephone service. The system further determines the number of times it may attempt to contact the customer before the cost of contacting the customer exceeds the value of the account.

### DESCRIPTION OF THE INVENTION

### FIELD OF THE INVENTION

The present invention relates generally to systems and methods for managing accounts, and more particularly to systems and methods for prioritizing accounts for contacting customers associated with those accounts.

### BACKGROUND OF THE INVENTION

Whether trying to contact a customer to sell a product or service, or to recover on a debt owed, a problem occurs when the money spent contacting the customer exceeds the money received. For example, a telemarketer may spend $10 trying to sell a product for $3, thus incurring a $7 loss even if the customer buys the product. Similarly, a customer may agree to purchase an offered product, only to deny payment at a later date. This action may create a loss if the sum of the money spent contacting the customer and the cost of the unpaid portion of the product exceeds any money eventually received.

Although telemarketers attempt to maximize profits by targeting customers who are likely to accept an offer, their attempt to predict an acceptance is simplistic and they do not consider the cost of contacting a customer or the amount a customer will likely pay for the offered product when determining whether to contact that customer. For example, a telemarketer may purchase lists of potential customers from a vendor and then purchase information from a credit bureau, for example, for each customer included in the list. The telemarketer may use a variable, such as income, to determine whether a customer is likely to accept an offer. For example, if a customer's income is above a certain level, the telemarketer may determine that a customer is likely to accept an offer. This type of model does not accurately predict whether a customer will accept an offer, because it is overly simplistic. Further, because the telemarketer does not consider the cost of contacting the client or the likelihood of the customer making payment, the telemarketer may incur a loss when, for example, selling to a customer with a pattern of delinquent payments or trying to sell to a customer who is difficult to contact.

Similarly, recovery services (i.e., services that attempts to collect debt which has been overdue for a lengthy period of time) do not weigh the amount of debt they are likely to collect against the cost of obtaining payment when deciding whether to contact a customer for payment. In fact, recovery services do not determine the probability of a customer making a payment. As described herein, a recovery service may also include a collection service or any other service used to collect debt on overdue payments.

These recovery services often fail to collect much of the debt from the accounts it seeks repayment. Although certain accounts are likely to pay, current recovery services do not adequately target those accounts for the reasons given above. Accordingly, such a service may spend more than the value of the debt it collects when attempting debt recovery.

Currently, many recovery services employ an age-value method to exclude certain accounts from recovery attempts. Before seeking repayment, the recovery service may obtain information about the account from a financial institution. This information may include the balance owed on the account, the age of the debt, and the address and telephone number of the account holder. The age-value method employed by the recovery service sets an age threshold for the debt and a value threshold for the account balance using this information. The method makes the following assumptions: (1) an older debt is less likely to be re-payed; and (2) small balances are not worth the expense of collection.

However, this method has several drawbacks. First, the method typically excludes only about 5% of accounts. Therefore, the recovery service still must attempt to collect from nearly every account, even though only a small percentage of accounts are likely to pay. Accordingly, the recovery service does not effectively reduce its expenses in seeking recovery. Second, the method uses factors (e.g., age of the debt and account balance) that do not accurately predict which accounts are likely to pay. Therefore, even the modest reduction of 5% does not adequately focus the recovery service on the optimal accounts. Finally, the method does not consider the difficulties, and hence the cost, in contacting specific account holders. For example, an account holder may be likely to pay, but difficult to reach because of outdated contact information. In such cases, the recovery service may spend more money in trying to locate the individual than it may eventually recover.

In view of the foregoing, there is presently a need for an improved system and method for determining whether to contact a party of the account. Specifically, there is a need to target only those customers who are likely to pay when contacted (e.g., sign up for a product or service or pay a debt) and who are not too costly to contact, thereby reducing costs and maximizing profits of the managing system.

### SUMMARY OF THE INVENTION

Systems and methods consistent with the principles of the present invention address the need to determine whether to contact a party of the account. Specifically, a method for managing an account to determine whether to contact a party associated with the account includes determining an account value for the account based on a likelihood of receiving payment on the account from the party, determining an account cost of obtaining payment from the account holder, and determining whether to contact the party of the account based on a comparison of the determined account value and account cost.

According to another aspect of the invention, a computer program is provided for determining whether to contact a party associated with an account. The computer program product comprises computer-readable media having computer-readable code. The computer-readable program code determines an account value for the account based on a likelihood of receiving payment on the account from the party, determines an account cost of obtaining payment from the party, and determines whether to contact the party of the account based on a comparison of the determined account value and account cost.

Further, a system determining whether to contact a party associated with an account, consistent with the present invention may include means for determining an account value for the account based on a likelihood of receiving payment on the account from the party, means for determining an account cost of obtaining payment from the party; and means for determining whether to contact the party of the account based on a comparison of the determined account value and account cost.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention. In the drawings:

FIG. 1 illustrates an exemplary system environment in which the features of the present invention may be implemented;

FIG. 2 is an exemplary flowchart of a method, consistent with the principles of the present invention, for prioritizing accounts for debt collection;

FIGS. 3A and 3B are exemplary flowcharts of a method, consistent with the principles of the present invention, for determining a potential account value; and

FIG. 4 is an exemplary graph illustrating the number of contacts that can profitably be made on a given account consistent with the principles of the present invention.

### DESCRIPTION OF THE PREFERRED EMBODIMENTS

Systems and methods consistent with the present invention, determine whether to contact a party associated with an account. To this end, the system may determine which account holders or customers to contact and how often. As described below, the system first determines an account value and a cost of contacting the customer. With this information, the system determines how many times the customer should be contacted before the cost of attempting contact exceeds the value of the account. The managing system will stop contact attempts when the cost of contacting the customer exceeds the value of the account. Although the example described below is for a recovery service, one skilled in the art can readily appreciate that the features of the present invention may be applied in any system that may decide whether to contact a customer based on the potential value of the customer and the likelihood of contact. For example, the present invention also relates to telemarketing systems as well as debt collection services.

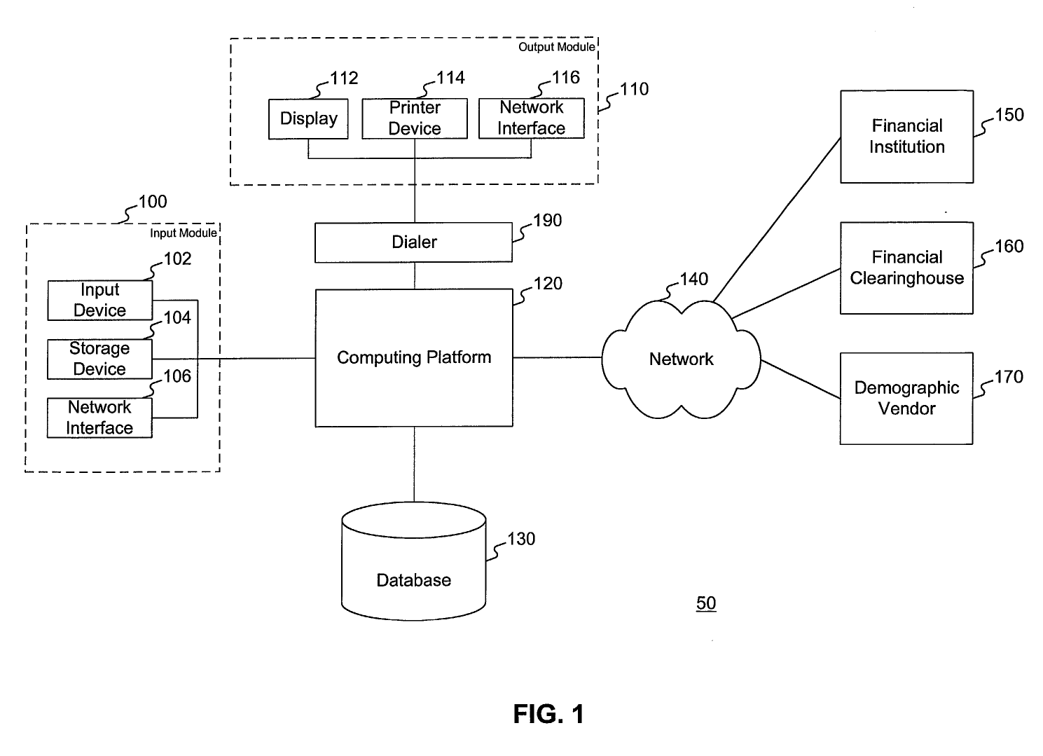

By way of a non-limiting example, FIG. 1 illustrates a system environment 50 for implementing the features and principles of the present invention. As illustrated in the block diagram of FIG. 1, system environment 50 includes an input module 100, an output module 110, a computing platform 120, a database 130, a network 140, a financial institution 150, a financial clearinghouse 160, a demographic vendor 170, and a dialer 190. Computing platform 120 provides the necessary functionality and computing capabilities to analyze each customer's credit history or financial data received over network 140 or from input module 100. Platform 120 may receive purchased account debt (e.g., for a recoveries service) or customer lists (e.g., for a telemarketing service) from a financial institute 150 over network 140. Network 140 may comprise, alone or in any suitable combination, a telephony-based network (such as a PBX or POTS), a local area network (LAN), a wide area network (WAN), a dedicated Internet, and/or the Internet. Information regarding these accounts may be stored in database 130.

Platform 120 may analyze each customer's credit history information accessed through a commercially available source (such as the FICO model from Fair, Isaac and Company, Inc.) and/or through a financial clearinghouse 160, such as a major credit bureau like TRW/Experian, Equifax, or TransUnion. With this account information, platform 120 may determine a potential value for each customer's account.

Platform 120 may also consider information received at the time of purchase, such as the age of the debt and the account balance, when determining the potential account value. Platform 120 may also analyze information received from a demographic vendor 170 to predict the cost of contacting each customer. Platform 120 may compare the potential value and predicted cost to determine a potential profitability level, including a determination of whether and how often to contact each customer for debt collection or to make a sale. Platform 120 then outputs the results of analyzed data to output module 110, which prints or displays the results, or outputs it to other system devices, and to dialer 190, which attempts to contact the customer. Output from computing platform 120 can also be provided to database 130, which may be utilized as a persistent storage device for storing, for example, the number of times dialer 190 has attempted to contact the customer, the maximum number of attempts that should be made for contacting the customer, and the results of each contact attempt (i.e., whether the customer was reached).

In the embodiment of FIG. 1, computing platform 120 preferably comprises a PC or mainframe computer for performing various functions and operations of the invention. Computing platform 120 may be implemented, for example, by a general purpose computer selectively activated or reconfigured by a computer program stored in the computer, or may be a specially constructed computing platform for carrying out the features and operations of the present invention. Computing platform 120 may also be implemented or provided with a wide variety of components or subsystems including, for example, one or more of the following: a central processing unit, a co-processor, memory, registers, and other data processing devices and subsystems. Computing platform 120 also communicates or transfers customer and credit data to and from input module 100 and output module 110 through the use of direct connections or other types of communication links, as illustrated in FIG. 1.

Alternatively, communication between computing platform 120 and modules 100, 110 can be achieved through the use of a network architecture (not shown). In the alternative embodiment (not shown), the network architecture may comprise, alone or in any suitable combination, a telephony-based network (such as a PBX or POTS), a local area network (LAN), a wide area network (WAN), a dedicated Internet, and/or the Internet. Further, it may comprise any suitable combination of wired and/or wireless components and systems. By using dedicated communication links or a shared network architecture, computing platform 120 may be located in the same location or at a geographically distant location from input module 100 and/or output module 110.

Input module 100 of system environment 50 may be implemented with a wide variety of devices to receive and/or provide the account data as input to computing platform 120. As illustrated in FIG. 1, input module 100 includes an input device 102, a storage device 104, and/or a network interface 106. Input device 102 may comprise a keyboard, a mouse, a disk drive or any other suitable input device for providing customer or credit data to computing platform 120. Memory device 104 may be implemented with various forms of memory or storage devices, such as read-only memory (ROM) devices and random access memory (RAM) devices, and may include a memory tape or disk drive for reading and providing the customer's financial information and credit history as input to computing platform 120 for the identification and review processes. Input module 100 may also include network interface 106, as illustrated in FIG. 1, to receive data over a network (such as a LAN, WAN, Internet or the Internet) and to provide the same as input to computing platform 120. For example, network interface 106 may be connected to a credit bureau (such as TRW/Experian, Equifax, or TransUnion) or a private database over a network for the purpose of receiving and transferring customer financial or credit data to computing platform 120.

As illustrated in FIG. 1, output module 110 includes a display 112, a printer device 114, and/or a network interface 116 for receiving the results provided as output from computing module 110. As indicated above, the output from computing platform may include a potential value of each customer's account, a prediction of the cost of contacting each customer, and/or a potential profitability level including a determination of whether and how often to contact each customer. The output from computing platform 120 may be displayed or viewed through display 112 (such as a CRT or LCD) and printer device 114. If needed, network interface 116 may also be provided to facilitate the communication of the results from computing platform 120 over a network (such as a LAN, WAN, Internet or the Internet) to remote or distant locations for further analysis or viewing. In either case, the output from output module 110 can be used by the credit card issuer to generate, for example, a chart indicating the maximum number of attempts that should be made for contacting each customer for debt recovery, debt collection, or to make a sale. The output from output module 110 can also be used for other purposes, such as internal reports or monitoring.

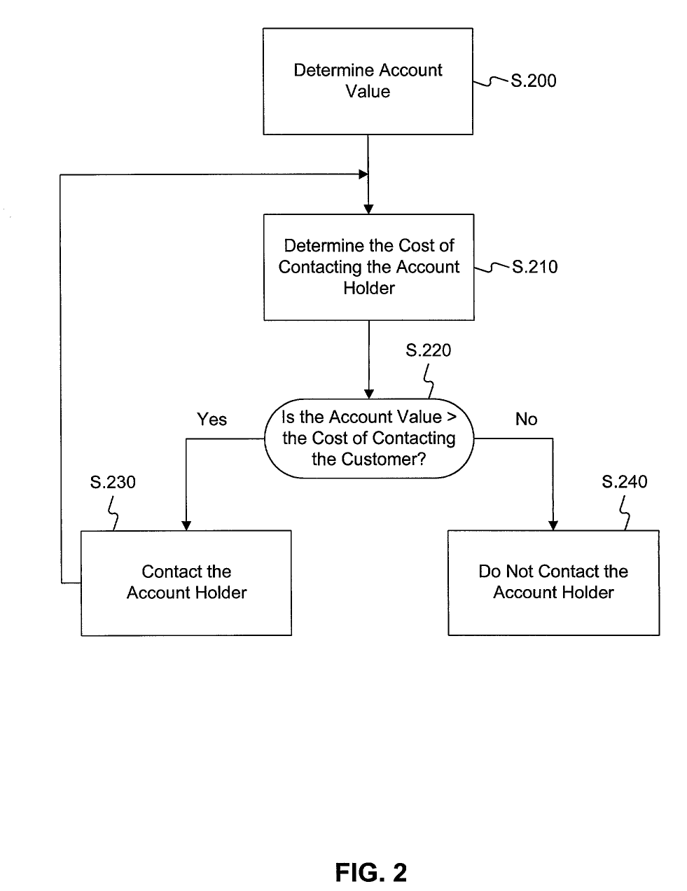

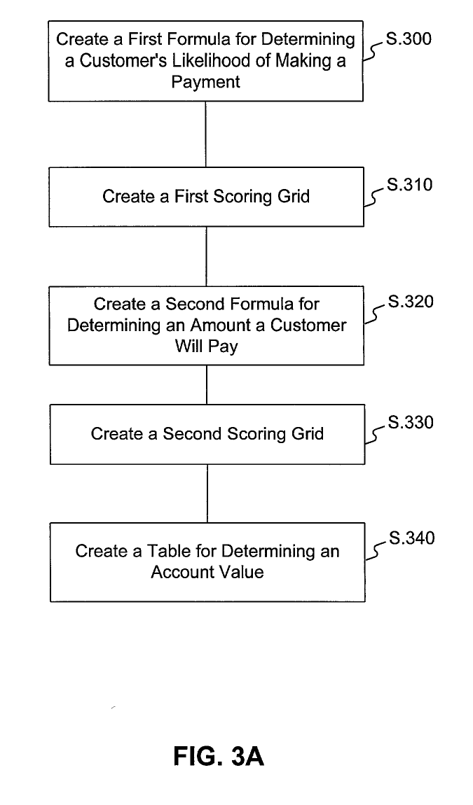

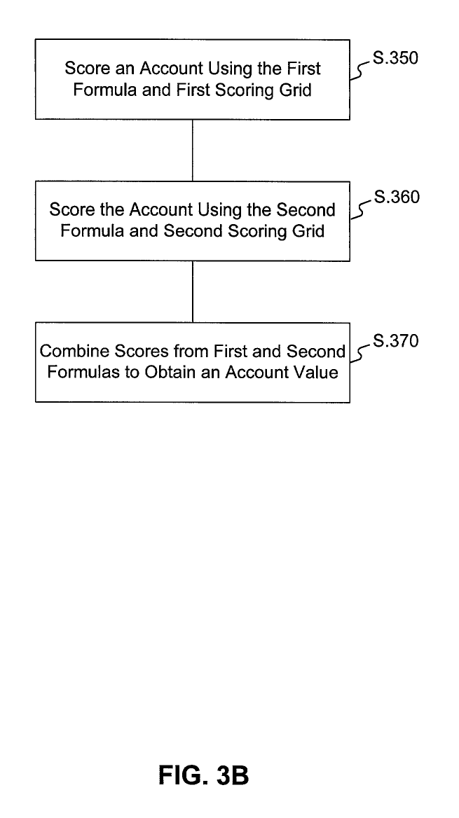

In accordance with the principles of the present invention, an exemplary process for determining whether to contact a party associated with an account will now be described with reference to FIGS. 2 and 3. FIG. 2 is an exemplary flowchart of a process for prioritizing accounts consistent with the principles of the present invention. As shown in FIG. 2, the method first determines a value of the account (step S.200). That is, computing platform 120 predicts an amount the customer would likely pay on the account if the customer was contacted. As part of this step, the method of the present invention may consider a number of variables reflecting the customer's current financial situation and credit history.

FIGS. 3A and 3B are exemplary flowcharts of a method for determining a potential account value consistent with the principles of the present invention. FIG. 3A is an exemplary flowchart of a method for generating a processing model, which is then used to determine an account value for each particular customer's account. As shown in FIG. 3A, the method creates a first formula for determining a customer's likelihood of making a payment (step S.300). In a telemarketing application, this step involves determining the probability that a customer will pay for the offered product or service (i.e., that the customer will accept the offer).

The first formula may be created from historical account data using a multivariate logistic regression model, which is well known in the art. The historical account data includes information from financial clearinghouse 160 and information regarding accounts for all customers. The account information includes information on all customers that have made previous payments and the amount of those payments. The account information may be obtained from the archived records in database 130 or another storage medium of system environment 50. Alternatively, the account information may be purchased from an outside vendor. The historical information from financial clearinghouse 160 (such as a credit bureau like Equifax) includes many statistics (such as those listed below) describing the financial situation of each customer listed in the account information.

The multivariate logistic regression model analyzes the historical account data to identify the combination of financial statistics, or variables, that best predicts the probability that a particular customer will make a payment. Most of the statistics or variables analyzed (e.g., a recovery score, debt-to-income ratio, a number of charged-off accounts with a balance greater than zero, FICO score, income, a number of satisfactory bankcard ratings, a number of bankcards opened in the past 24 months, a number of credit inquiries made in the past 6 months, and a number of accounts with delinquent payments of at least 90 days) are obtained through financial clearinghouse 160. However, some variables, such as the age of the debt and account balance (e.g., for a recovery service application), are received at the time the account was purchased from financial institute 150. Other variables may also be determined in-house by computing platform 120. Although the regression model initially identifies the variables, the variables used may be changed at a later time to comply with experimental data, for example. One skilled in the art will readily appreciate the flexibility of the present invention in selecting both the type and amount of variables identified.

After the multivariate logistic regression model identifies the most predictive variables (such as the top 10-15 predictive financial statistics) for determining whether a client will make a payment, it creates the first formula including only the identified variables. The first formula weights each identified variable to minimize the error in predicting whether a customer will pay. For example, the multivariate logistic regression model may, by using regression techniques well known in the art, weigh the most predictive of the identified variables more heavily than the least predictive of the identified variables. In a recovery service application consistent with the present invention, the three most heavily weighted financial statistics or variables may include a customer's debt-to-income ratio, the total number of charged-off accounts with a balance greater than zero, and the recovery score, for example.

Also, the weights may account for differences in the types of data analyzed. For example, the first formula allows percentages, probabilities, numbers, and dollar amounts to be entered simultaneously. A small number, such as a probability (ranging from 0-1), may be weighted more heavily than a large number, such as income, to account for the different data types. As described above, formulas with weighted variables created by a logistic regression model are well known in the art. Although the multivariate logistic regression model described herein initially determines the weights, one skilled in the art can appreciate that the weights may be modified later to comply with experimental results or other personal experience, for example.

After generating the first formula, computing platform 120 creates a first scoring grid using the historical account data (step S.310). As a part of this step, computing platform 120 uses the determined weighted combination of variables to further determine a probability of receiving payment, ranging from 0-1, for each account included in the entered historical account data. Computing platform 120 then generates a scoring table by dividing these probabilities into predetermined groups. For example, the probabilities may be divided into five groups, each group receiving a score ranging from 1 (low) to 5 (high). In a preferred embodiment, computing platform 120 determines the range of probabilities for each group according to the percentage of accounts that fall within that range. For example, the range of probabilities containing the highest 20% of the probability scores receives a score of 5. The range containing the next highest 20% of the probability scores receives a score of 4, etc. In this manner, the population is equally distributed among the groups. One skilled in the art can recognize that other scoring methods are possible. For example, in another embodiment the computing platform may determine the groups by dividing the probabilities into equal ranges. For example, a probability range from 1 to 0.8 may receive a score of 5 and a range from 0.8 to 0.6 may receive a score of 4.

Computing platform 120 then generates a second formula for determining an amount a customer will likely pay (step S.320). The second formula assumes the customer will make a payment. Therefore, the historical credit and account data analyzed to generate the second formula includes only data from accounts which have made a payment (e.g., for a recovery service or collection service application) or have agreed to purchase a service or product (e.g., for a telemarketing service application). As described above with respect to step S.300, the information analyzed by the second formula may be obtained from archived records stored in database 130 or from financial clearinghouse 160.

The second formula may be created from the historical data using a multivariate linear regression model, which is also well known in the art. The techniques for generating the second formula with the multivariate linear regression model are the same as those used to generate the first formula. In particular, the multivariate linear regression model identifies the combination of variables that minimizes the error in predicting the amount a customer will pay. The variables analyzed are the same variables analyzed in the first model described above. However, the variables identified as the most predictive may differ.

After the most predictive variables are identified (such as the top 10-15 variables), the multivariate linear regression model generates the second formula including the identified variables. The second formula weights each variable to minimize error in predicting the amount a customer will pay on the account, as described above for the first formula. The multivariate linear regression model is well known in the prior art for analyzing data to generate a formula defining a “best fit” line (i.e., a line that minimizes the error, or distance squared to the variables). However, one skilled in the art will recognize the flexibility of using other variables or predictive models to generate a formula for predicting an amount a customer will likely pay.

After generating the second formula, computing platform 120 creates a second scoring grid using the relevant historical data (i.e., accounts that have made a payment) (step S.330). Namely, for each historical account having a payment made, computing platform 120 enters the financial statistics or variables into the second formula. After all the historical data has been used to generate a predicted amount, the second scoring grid is generated by dividing these amounts into predetermined groups. For example, the predicted amounts may be divided into five groups, each group receiving a score ranging from 1 (low) to 5 (high). In a preferred embodiment, computing platform 120 determines the range of amounts for each group according to the percentage of accounts that fall within that range. For example, the range corresponding to the highest 20% of the generated payment amounts receives a score of 5. The range corresponding to the next highest 20% receives a score of 4, etc.

Computing platform 120 may then use the historical data to combine the first and second scoring grids into a matrix for predicting the overall account value, such as that shown in Table 1 below (step S.340). Each account value in Table 1 corresponds to a particular score generated from the first formula and first scoring grid and a particular score generated from the second formula and second scoring grid. Each value in the table is within a predetermined range, such as from 1 (low) to 8 (high). Each value in the table may then be associated with a particular range of dollar account values.

Computing platform 120 generates a numerical overall account value for each score combination by analyzing historical account and credit information. Particularly, computing platform may generate a logistic regression score and a linear regression score for each archived account in database 130, using the first formula and first scoring grid and the second formula and second scoring grid, respectively. After generating the logistic regression and linear regression scores, computing platform 120 analyzes the archived account data to determine the actual overall account values for each possible combination of linear regression and logistic regression scores, so that the error in predicting the account value is minimized.

In general, high scores from both the linear regression model and the logistic regression model yield a high account value, and vice versa. If one model outputs a high score and the other a low score, the resulting account value lies somewhere between the scores, with the logistic regression model (i.e., the first formula) being weighted slightly more heavily, however. For example, Table 1 shows that a linear regression score of 5 and a logistic regression score of 1 yields an account value of 2. However, a linear regression score of 1 and a logistic regression score of 5 yields a score of 6, since the logistic regression model score is weighted more heavily.

TABLE 1
Account Value
Linear Regression Model Score

| | | | | | |
|---|---|---|---|---|---|
| Logistic Regression | 5 | 4 | 3 | 2 | 1 |
| Model Score | | | | | |
| 5 | 8 | 8 | 7 | 7 | 6 |
| 4 | 8 | 6 | 6 | 5 | 5 |
| 3 | 7 | 5 | 4 | 3 | 3 |
| 2 | 4 | 4 | 3 | 1 | 1 |
| 1 | 2 | 2 | 2 | 1 | 1 |

The first and second formulas, the first and second scoring grids, and the account value table for combining the scores, may then be used to predict an account value for a particular customer's account. FIG. 3B is an exemplary flowchart of a method for using the determined processing model to determine an account value for a particular customer's account. As shown in FIG. 3B, the method scores an account using the first formula and the first scoring grid (step S.350). More particularly, computer platform 120 enters the required variables from the particular customer's credit history and financial information into the first formula to obtain a probability that the customer will make a payment. Computing platform 120 then uses the first scoring grid to determine a score (e.g., 1-5) for the customer based on the determined

Computing platform 120 also enters the required variables from a customer's credit history and financial information into the second formula to obtain an amount the customer will likely pay if he makes a payment (step S.360). Computing platform 120 uses the second scoring grid to determine a linear regression model score for the customer based on the calculated amount. Computing platform 120 then applies the determined scores to a matrix, such as that shown in Table 1, to obtain an overall account value (step S.370). Each determined overall account value relates to a predefined dollar range of account values.

Returning to FIG. 2, after determining the value of the account, computing platform 120 determines an estimated cost of contacting the account holder (step S.210). Computing platform 120 generates a formula and scoring grid for determining the likelihood of contacting a customer. Computing platform 120 generates the cost formula using a multivariate logistic regression model, such as that described above. The data analyzed by the regression model in determining the likelihood of contacting a customer, however, differs from the data analyzed to determine the likelihood of a customer making a payment, as described with respect to step S.300. Specifically, the data analyzed for determining the probability of contact includes historical demographic information, accessed from demographic vendor 170, if available, and account information, such as whether the customer was previously contacted and the age of the debt.

The multivariate logistic model separately analyzes the data from accounts not having demographic information, thereby generating a separate cost formula with the multivariate logistic regression model. This separate cost formula only has financial statistics or variables obtained from the account information, such as the age of the debt and whether the customer was previously contacted. Because the separate cost formula is used to analyze financial statistics or variables for customers without available demographic information, and not the majority of customers with available demographic information, it will be referred to hereinafter as the “back-up cost formula.”

Although the account managing system may contact a customer based on information originally provided by financial institute 150 (e.g., when it sold the account debt to the recovery service), the present invention may also send a list of names and addresses to a demographic vendor 170 to obtain updated customer contact information. For example, demographic vendor 170 provides to computing platform 120 the name and address of each customer it locates based upon original contact information provided to computing platform 120. If demographic vendor 170 can locate the name and address of a customer, it provides information regarding the characteristics of a population in the customer's geographic area, which is then used by the multivariate logistic regression model to generate the cost formula predicting a likelihood of contacting a customer in that geographic area. Otherwise, computing platform 120 separately analyzes the historical account information of the accounts without demographic information using the multivariate logistic regression model to generate the back-up cost formula for calculating the likelihood of contacting the customer. The demographic information may be stored in database 130 with the other account information. Alternatively, the historical demographic and account data may be purchased from an outside vendor.

The variables analyzed from the demographic information include, for example, the average and median length of residence, the number of people owning homes, the number renting apartments, the percentage of people who were born in the state, the percentage of people who are enrolled in college, the percentage of people employed in a professional capacity, the average number of adults in a home, the median household income, and the average car retail value for people living within a particular geographic area. Other financial statistics or variables analyzed by the multivariable logistic regression model includes account information, such as the age of the debt and whether the customer was contacted, and variables generated by computing platform 120. For example, computing platform 120 may generate a variable corresponding to whether demographic vendor 170 could find the name and address of the customer. The multivariable logistic regression model identifies which of these variables best predicts whether a customer will be successfully contacted and weights the identified variables in a formula for determining this probability. The variables are weighted, using the historical demographic and account data, to minimize error in calculating the probability of contacting a particular customer.

Systems and methods consistent with the present invention may assign a lower probability of contacting customers who live in a transient population or an area that lacks telephone service. More particularly, the multivariate logistic model may rate a customer located in a predominately “young” or urban area with a low probability of contact. Although people in urban areas tend to have telephone service, they also tend to relocate often, making them harder to track despite them having telephone service. Similarly, a person located in the suburbs may have a higher probability of contact, because they tend to stay in the same location and have telephone service. Further, the multivariate logistic model may rate a customer located in a remote area that tends to lack telephone service with a lower probability of contact.

Computing platform 120 then creates a scoring grid for scoring the range of probabilities, as discussed above, for example, with respect to FIG. 3. More specifically, the probabilities generated for each of the accounts is divided into predetermined groups. Each group receives a score within a predetermined range. In a preferred embodiment, the generated probabilities are divided into ten groups, with the value of each group ranging from 1 (low) to 10 (high). In this case, the range of probabilities generated with the historical data and containing the highest 10% of the probability scores, preferably receives a score of 10. The range containing the next highest 10% of the probability scores receives a score of 9, etc.

After generating the cost formula and scoring grid, computing platform 120 may adjust the scoring grid, for example, into seven groups ranging in value from 1-7. The scoring grid may be adjusted by determining whether the demographic vendor 170 found the customer's name and address information. This adjustment serves to weight this statistic or variable more heavily, thereby recognizing that dialer 190 will not likely contact the customer if the customer cannot be found. Alternatively, the formula for predicting the probability of contact may be optimized by weighing this statistic or variable more heavily, so that the scores do not need further adjustment, for example.

Each score (e.g., 1-7) in the adjusted scoring grid corresponds to a predefined range of costs associated with contacting the customer. The relationship between the probability of contact and the cost of contact is inverse. For example, if the probability of contacting the customer is low, then dialer 190 will likely need to attempt contacting the customer several times before successfully doing so, causing the cost to be high. Similarly if the probability of contacting the customer is high, then dialer 190 will likely attempt to contact the customer only a few times before successfully doing so, causing the cost to be low. One skilled in the art will recognize that various factors, weights, and values may be used to determine the formula for determining the likelihood of contacting the customer.

Returning to FIG. 2, after determining the estimated value of the account and the expected cost of contacting the customer, computing platform 120 determines whether to contact the customer. Computer platform 120 bases this decision on the potential profitability of the account, by comparing account value to the cost of contacting the customer (step S.220). If the account value is greater than the cost of the contacting the customer, dialer 190 attempts contacting the customer to collect a debt or to make a sale (step S.230). Otherwise, dialer 190 does not attempt to contact the account holder (step S.240). By focusing on customers who are more likely to pay their debt or an product they agreed to purchase and are easier to contact, a managing system may maximize its profits. In this respect, systems and methods consistent with the present invention may reduce the number of accounts that are pursued for recoveries, for example, by about 50%.

Further, once dialer 190 decides to contact the customer, it may continue attempting to contact the customer until the cost of contact exceeds or equals the account value. Particularly, by determining the initial cost of attempting to contact a customer, computing platform 120 also may determine how often dialer 190 may profitably attempt to contact a customer (i.e., how many additional calls, for example, can be made before the estimated cost of contacting the customer exceeds the estimated account value.) More specifically, computing platform 120 may update the adjusted cost scores (e.g., 1-7) to determine the probability of contacting the customer as the number of attempted contacts increase. Particularly, an adjusted cost score may be lower to reflect that the probability of contacting the customer decreases as the number of contacts increase. The lower probability, which indicates a higher cost for attempting contact, may be used to determine the number of times dialer 190 should attempt to contact the customer before the expected costs exceed the account value. Alternatively, the formula generated with a logistic regression model and historical demographic and account data may be modified to include the number of contacts attempted as a variable. In this embodiment, a new probability score may be calculated for each attempted contact to determine how often dialer 190 may attempt to contact a customer profitably.

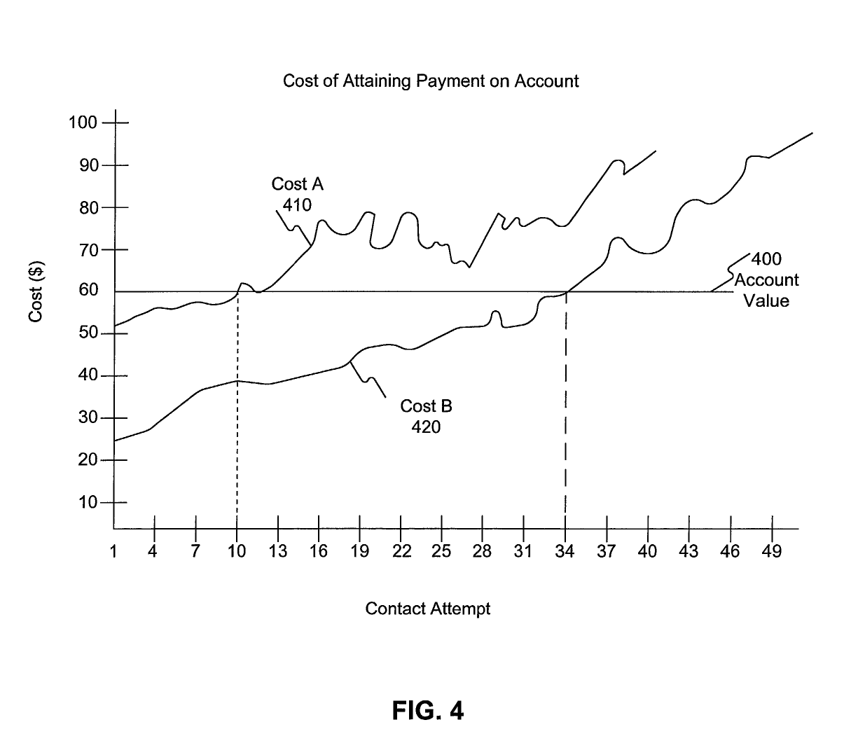

FIG. 4 is an exemplary graph illustrating the number of contacts that can profitably be made on a given account consistent with the principles of the present invention. In a preferred embodiment, the system contacts the customer by telephone. However, other methods of contact, such as mail, electronic mail, or facsimile may be implemented.

FIG. 4 illustrates two accounts, A and B. Both accounts have an estimated account value 400 of $60, which may be determined as described above with respect to step S.200. As shown in FIG. 4, the estimated cost of initially contacting customers A and B (e.g., approximately $52 and $25, respectively) is less than the account value. Therefore, as described above with respect to step S.230, dialer 190 may attempt contacting customers A and B. This contact may be repeated until the cost of attempting contact exceeds the account value.

Although both accounts have an account value of $60, a recovery service may attempt contacting customer B more often than A. As shown in FIG. 4, customer A has a higher cost per contact attempt 410 than customer B. Specifically, the cost per contact attempt 410 shows that account value 400 equals the estimate cost at 10 attempts. Therefore, to maintain a possible profit for account A, dialer 190 should make less than 10 attempts to contact customer A. Similarly, the cost per contact attempt 420 shows that 34 contact attempts may be made to customer B before the costs exceed the account value 400.

Using this information, dialer 190 determines when to stop attempting to contact the customer. For example, if no contact has been made with the customer during previous calls, computing platform 120 may check database 130 to determine whether to attempt another call. If the number of attempted calls is less than or equal to the maximum permitted calls, computing platform 120 allows the recovery service to make the call. However, if the number is greater than the maximum permitted, computing platform 120 indicates a call cannot be made.

If database 130 indicates that contact has been made with the customer, the method may differ depending on the application. For example, dialer 190 may continue contacting the customer once contact is made, without regard to the maximum number of attempted contacts, if the method is applied in a recoveries service or a collection service. In these applications, the customer may be contacted until the debt is collected or until dialer 190 is informed that the debt cannot be collected due to bankruptcy or death of the debtor, for example. However, dialer 190 may stop contacting the customer once the maximum number of attempted contacts is reached, regardless of whether the customer was contacted, if the method is applied in a telemarketing service.

Systems consistent with the present invention overcome the shortcomings of conventional apparatus and methods for determining whether to contact a party of the account. By prioritizing accounts, as described herein, systems and methods consistent with the present invention minimize the expense incurred during any outbound calling service, thereby maximizing profits. Applications for the present invention include telemarketing, debt collection, and debt recovery service. For example, in a telemarketing system consistent with the present invention predicts, the likelihood of the customer accepting the offer, the amount the customer will likely pay for the product or service if an offer is accepted, and the cost of attempting to sell the product or service are calculated and combined to determine whether to contact the customer. Similarly, in a collecting service or recovery service consistent with the present invention predicts, the likelihood of the customer paying debt owed, the amount the customer will likely pay if a payment is made and the cost of attempting to contact the customer are calculated and combined to determine whether to contact the customer.

The above-noted features and other aspects and principles of the present invention may be implemented in various system or network environments to provide automated computational tools to facilitate data collection and risk analysis of accounts. Such environments and applications may be specially constructed for performing the various processes and operations of the invention or they may include a general-purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by compiler, and files containing a high level code that can be executed by the computer using an interpreter.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A method for managing an account to determine whether to contact a party associated with the account, said method comprising:
determining an account value of the account based on a likelihood of receiving a payment on the account and an amount likely to be received from the associated party when the associated party is contacted;
determining an account cost based on a likelihood of contacting the associated party, wherein the account cost represents the cost of obtaining payment from the associated party; and
determining whether to contact the party associated with the account based on a comparison of the determined account value and the determined account cost.

2. The method of claim 1, wherein determining an account value includes:
determining the likelihood of receiving the payment on the account from the associated party;
determining the amount that the associated party is likely to pay on the account; and
combining the likelihood of receiving payment and the amount that the associated party is likely to pay on the account into an overall account score reflecting the account value.

3. The method of claim 2, wherein determining the likelihood of receiving payment is based on financial information of the associated party.

4. The method of claim 2, wherein determining the likelihood of receiving payment further includes:
analyzing whether payment was received on other accounts from parties associated with those other accounts; and
determining the likelihood of receiving payment from the associated party based on the analysis of the other accounts.

5. The method of claim 2, wherein determining the likelihood of receiving payment from the associated party further includes:
using a logistic regression model to describe the likelihood of receiving payment based upon predefined account criteria;
applying information about the account to the logistic regression model to determine a likelihood score; and
determining the likelihood of receiving payment based upon the determined likelihood score.

6. The method of claim 2, wherein determining the amount likely to be paid is based on financial information of the associated party.

7. The method of claim 2, wherein determining the amount likely to be paid further includes:
analyzing whether amounts paid on other accounts from parties associated with those other accounts; and
determining the amount likely to be paid based on the analysis of the other accounts.

8. The method of claim 2, wherein determining the amount likely to be paid further includes:
using a linear regression model to describe the amounts likely to be paid on particular accounts based upon predefined account criteria;
applying information about the account to the linear regression model to determine a likelihood score; and
determining the amount likely to be paid based upon the determined likelihood score.

9. The method of claim 1, wherein determining the account cost includes:
determining the likelihood of contacting the associated party based on a demographic area in which the associated is located.

10. The method of claim 9, wherein determining the likelihood of contacting the associated party further includes:
using a logistic regression model to describe the likelihood of contacting a party located in a particular demographic area;
applying information about the demographic area of the associated party to the logistic regression model to determine a likelihood score; and
determining the likelihood of contacting the associated party based upon the determined likelihood score.

11. The method of claim 1, further including:
decreasing the likelihood of contacting the associated party with each attempt at contacting the associated party.

12. The method of claim 1, wherein determining an account cost includes:
finding a higher account cost when the likelihood of contact is low and a lower account cost when the likelihood of contact is high.

13. The method of claim 1, wherein determining whether to attempt contacting the party includes:
determining whether the determined account value exceeds the determined account cost; and
attempting to contact the associated party when the determined account value exceeds the account cost.

14. The method of claim 13, further including:
determining a number of contact attempts that can be made before the account cost exceeds the account value.

15. A computer program product for managing an account to determine whether to contact a party associated with the account, the computer program product comprising computer-readable media having computer-readable code, the computer program product comprising the following computer-readable program code for effecting actions in a computing platform:
program code for determining an account value of the account based on a likelihood of receiving a payment on the account and an amount likely to be received from the associated party when the associated party is contacted;
program code for determining an account cost based on a likelihood of contacting the associated party, wherein the account cost represents the cost of obtaining payment from the associated party; and
program code for determining whether to contact the party associated with the account based on a comparison of the determined account value and the determined account cost.

16. The computer program product of claim 15, wherein the program code for determining an account value includes:
program code for determining the likelihood of receiving the payment on the account from the associated party;
program code for determining the amount that the associated party is likely to pay on the account; and
program code for combining the likelihood of receiving payment and the amount that the associated party is likely to pay on the account into an overall account score reflecting the account value.

17. The computer program product of claim 16, wherein the program code for determining the likelihood of receiving payment is based on financial information of the associated party.

18. The computer program product of claim 16, wherein the program code for determining the likelihood of receiving payment further includes:
program code for analyzing whether payment was received on other accounts from parties associated with those other accounts; and
program code for determining the likelihood of receiving payment from the associated party based on the analysis of the other accounts.

19. The computer program product of claim 16, wherein the program code for determining the likelihood of receiving payment from the associated party further includes:
program code for a logistic regression model describing the likelihood of receiving payment based upon predefined account criteria;
program code for applying information about the account to the logistic regression model to determine a likelihood score; and
program code for determining the likelihood of receiving payment based upon the determined likelihood score.

20. The computer program product of claim 16, wherein the program code for determining the amount likely to be paid is based on financial information of the associated party.

21. The computer program product of claim 16, wherein the program code for determining the amount likely to be paid further includes:
program code for analyzing whether amounts paid on other accounts from parties associated with those other accounts; and
program code for determining the amount likely to be paid based on the analysis of the other accounts.

22. The computer program product of claim 16, wherein the program code for determining the amount likely to be paid further includes:
program code for a linear regression model describing the amounts likely to be paid on particular accounts based upon predefined account criteria;
program code for applying information about the account to the linear regression model to determine a likelihood score; and
program code for determining the amount likely to be paid based upon the determined likelihood score.

23. The computer program product of claim 15, wherein the program code for determining the account cost includes:
program code for determining the likelihood of contacting the associated party based on a demographic area in which the associated is located.

24. The computer program product of claim 23, wherein the program code for determining the likelihood of contacting the associated party further includes:
program code for a logistic regression model describing the likelihood of contacting a party located in a particular demographic area;
program code for applying information about the demographic area of the associated party to the logistic regression model to determine a likelihood score; and
program code for determining the likelihood of contacting the associated party based upon the determined likelihood score.

25. The computer program product of claim 15, further including:
program code for decreasing the likelihood of contacting the associated party with each attempt at contacting the associated party.

26. The computer program product of claim 15, wherein the program code for determining an account cost includes:
program code for finding a higher account cost when the likelihood of contact is low and a lower account cost when the likelihood of contact is high.

27. The computer program product of claim 15, wherein the program code for determining whether to attempt contacting the party includes:
program code for determining whether the determined account value exceeds the determined account cost; and
program code for attempting to contact the associated party when the determined account value exceeds the account cost.

28. The computer program product of claim 27, further including:
program code for determining a number of contact attempts that can be made before the account cost exceeds the account value.

29. A system for managing an account to determine whether to contact a party associated with the account, said system comprising:
means for determining an account value of the account based on a likelihood of receiving a payment on the account and an amount likely to be received from the associated party when the associated party is contacted;
means for determining an account cost based on a likelihood of contacting the associated party, wherein the account cost represents the cost of obtaining payment from the associated party; and
means for determining whether to contact the party associated with the account based on a comparison of the determined account value and the determined account cost.

30. The system of claim 29, wherein the means for determining an account value includes:
means for determining the likelihood of receiving the payment on the account from the associated party;
means for determining the amount that the associated party is likely to pay on the account; and
means for combining the likelihood of receiving payment and the amount that the associated party is likely to pay on the account into an overall account score reflecting the account value.

31. The system of claim 30, wherein the means for determining the likelihood of receiving payment is based on financial information of the associated party.

32. The system of claim 30, wherein the means for determining the likelihood of receiving payment further includes:
means for analyzing whether payment was received on other accounts from parties associated with those other accounts; and
means for determining the likelihood of receiving payment from the associated party based on the analysis of the other accounts.

33. The system of claim 30, wherein the means for determining the likelihood of receiving payment from the associated party further includes:
means for using a logistic regression model to describe the likelihood of receiving payment based upon predefined account criteria;
means for applying information about the account to the logistic regression model to determine a likelihood score; and
means for determining the likelihood of receiving payment based upon the determined likelihood score.

34. The system of claim 30, wherein the means for determining the amount likely to be paid is based on financial information of the associated party.

35. The system of claim 30, wherein the means for determining the amount likely to be paid further includes:
means for analyzing whether amounts paid on other accounts from parties associated with those other accounts; and
means for determining the amount likely to be paid based on the analysis of the other accounts.

36. The system of claim 30, wherein the means for determining the amount likely to be paid further includes:
means for using a linear regression model to describe the amounts likely to be paid on particular accounts based upon predefined account criteria;
means for applying information about the account to the linear regression model to determine a likelihood score; and
means for determining the amount likely to be paid based upon the determined likelihood score.

37. The system of claim 29, wherein the means for determining the account cost includes:
means for determining the likelihood of contacting the associated party based on a demographic area in which the associated is located.

38. The system of claim 37, wherein the means for determining the likelihood of contacting the associated party further includes:
means for using a logistic regression model to describe the likelihood of contacting a party located in a particular demographic area;
means for applying information about the demographic area of the associated party to the logistic regression model to determine a likelihood score; and
means for determining the likelihood of contacting the associated party based upon the determined likelihood score.

39. The system of claim 29, further including:
means for decreasing the likelihood of contacting the associated party with each attempt at contacting the associated party.

40. The system of claim 29, wherein the means for determining an account cost includes:
means for finding a higher account cost when the likelihood of contact is low and a lower account cost when the likelihood of contact is high.

41. The system of claim 29, wherein the means for determining whether to attempt contacting the party includes:
means for determining whether the determined account value exceeds the determined account cost; and
means for attempting to contact the associated party when the determined account value exceeds the account cost.

42. The system of claim 41, further including:
means for determining a number of contact attempts that can be made before the account cost exceeds the account value.
